(19) United States
(12) Patent Application Publication
(10) Pub. No.: US 2020/0276570 A1
(43) Pub. Date: Sep. 3, 2020

(54) METHOD FOR PRODUCING PHOTOCATALYST MATERIAL, METHOD FOR PRODUCING MATERIAL FOR PHOTOELECTRIC CONVERSION ELEMENTS, METHOD FOR PRODUCING WEAR-RESISTANT MEMBER, METHOD FOR PRODUCING MEMBER FOR PREVENTING DETERIORATION OF EDIBLE OILS, PHOTOCATALYST MATERIAL, MATERIAL FOR PHOTOELECTRIC CONVERSION ELEMENTS, WEAR-RESISTANT MEMBER, AND MEMBER FOR PREVENTING DETERIORATION OF EDIBLE OILS

(71) Applicant: S.O.W. INC., Tokyo (JP)

(72) Inventors: Daisuke TAKAHASHI, Tokyo (JP); Teruki TAKAYASU, Ikoma-shi, Nara (JP)

(21) Appl. No.: 16/650,201

(22) PCT Filed: May 10, 2018
(86) PCT No.: PCT/JP2018/018037

§ 371 Date: Mar. 24, 2020

(30) Foreign Application Priority Data
Sep. 29, 2017 (JP) 2017-190664

(51) Int. Cl. B01J 37/02; B01J 27/22; B01J 27/24; B01J 37/08; C25D 11/26

(52) U.S. Cl. CPC B01J 37/0226; B01J 27/22; C25D 11/26; B01J 37/08; B01J 27/24

(57) ABSTRACT

An object is to produce a titanium material with a crystalline titanium oxide film formed on the surface thereof. The titanium material with a crystalline titanium oxide film formed on the surface thereof is useful as a photocatalyst material, a photoelectric conversion element material, a wear-resistant member, an edible oil deterioration-preventing member, and the like that have high functionality.

Provided is a method for producing a titanium material with a crystalline titanium oxide film formed on the surface thereof, the method comprising:
(1) performing roughening treatment on the surface of a titanium material to form a roughened material,
(2) forming a titanium compound on the surface of the roughened material obtained in step (1),
(3) performing anodizing treatment on the material with the titanium compound formed on the surface thereof to form an amorphous titanium oxide film, and
(4) performing heat treatment on the material with the amorphous titanium oxide film formed on the surface thereof in an air atmosphere at a temperature of 300° C. or more to form a crystalline titanium oxide film.

### TECHNICAL FIELD

The present invention relates to a method for producing a metal titanium material or titanium alloy material with a crystalline titanium oxide film formed on the surface thereof, and a metal titanium material or titanium alloy material with a crystalline titanium oxide film formed on the surface thereof obtained by this production method.

### BACKGROUND ART

Titanium oxide is expected to be applied to photocatalyst materials that decompose various hazardous substances, and to dye-sensitized solar cells, which can be produced by simple methods and thus have attracted attention as next-generation solar cells. Titanium oxide has three types of crystal structures: rutile-type, brookite-type, and anatase-type. Of these three types, anatase-type titanium oxide is known to have excellent photocatalytic characteristics and photoelectric conversion characteristics for dye-sensitized solar cells.

PTL 1 discloses a technique of forming anatase-type titanium oxide on metal titanium or a titanium alloy by subjecting a metal titanium material or titanium alloy material to the following steps: (i) forming titanium nitride on the surface of titanium or a titanium alloy, and then (ii) performing anodizing treatment by applying a voltage equal to or higher than spark discharge generation voltage in an electrolyte solution containing an acid that has an etching effect on metal titanium. Members formed by this method can be preferably used as photocatalyst materials and photoelectric conversion element materials.

In the technique of PTL 1, a strong acid, such as sulfuric acid, is used in the etching of metal titanium, which has extremely high corrosion resistance. In this method, anodizing treatment was performed at a voltage higher than spark discharge generating voltage; thus, an expensive power supply capable of outputting a high voltage and a high current was required. Further, in this method, an expensive cooling device is required in order to suppress the heat generation of the electrolyte solution due to the generation of spark discharge.

PTL 2 discloses a technique that utilizes a member produced using the technique of PTL 1 for edible oil deterioration-preventing members.

PTL 3 discloses a technique of forming anatase-type titanium oxide on metal titanium or a titanium alloy by subjecting metal titanium or a titanium alloy to the following steps: (i) forming titanium nitride on the surface of titanium or a titanium alloy, then (ii) performing anodization in an electrolyte solution containing an acid that has no etching properties for metal titanium to form a titanium oxide film, and further (iii) performing heat treatment in an air oxidizing atmosphere or the like. Members formed by this method can be preferably used as photocatalysts, photoelectric conversion element materials, and wear-resistant members.

In the technique of PTL 3, since anodizing treatment is performed using an electrolyte solution having no etching properties for titanium, there is no need to use a strong acid, such as sulfuric acid; thus, this technique has extremely low work-related risk. Further, in this method, since anodizing treatment that generates spark discharge is not performed, harmful mist or gas is not generated, and the electrolyte solution generates little heat; thus, this technique is suitable for mass production.

In the technique of PTL 3, since anodizing treatment is performed in an electrolyte solution having no etching properties for titanium, the surface of the resulting member is not so rough, as compared with intense anodizing treatment that generates spark discharge in an electrolyte solution having etching properties for titanium (PTL 1).

PTL 4 is a technique that utilizes a member produced using the technique of PTL 3 for edible oil deterioration-preventing members.

PTL 5 discloses a material produced without the step of forming a titanium compound.

### CITATION LIST

### Patent Literature

### PTL 1: JP3858058B

### PTL 2: JP2011-200406A

### PTL 3: JP5452744B

### PTL 4: JP5490303B

### PTL 5: JP2008-184652A

### SUMMARY OF INVENTION

### Technical Problem

An object of the present invention is to produce a metal titanium material or titanium alloy material with a crystalline titanium oxide film formed on the surface thereof.

The metal titanium material or titanium alloy material with a crystalline titanium oxide film formed on the surface thereof is useful as a photocatalyst material, a photoelectric conversion element material, a wear-resistant member, an edible oil deterioration-preventing member, and the like that have high functionality.

### Solution to Problem

For metal titanium materials or titanium alloy materials, a technique of further increasing the amount of anatase-type titanium oxide formed on the surface thereof is required.

As a result of intensive studies, the present inventors found that in the production of a metal titanium material or titanium alloy material with a larger amount of crystalline titanium oxide film formed on the surface thereof (hereinafter also referred to as the “titanium material”), the amount of crystalline titanium oxide film formed on the surface of the titanium material can be further increased by (1) performing roughening treatment on the surface of the titanium material, (2) forming a titanium compound on the surface, (3) performing anodizing treatment on the material, and (4) performing heat treatment on the material under an air atmosphere or the like (surface treatment technique).

The present invention relates to a method for producing a titanium material with a crystalline titanium oxide film formed on the surface thereof. The titanium material with a crystalline titanium oxide film formed on the surface thereof is useful as a photocatalyst material, a photoelectric conversion element material, a wear-resistant member, an edible oil deterioration-preventing member, and the like that have high functionality.

Item 1. A method for producing a metal titanium material or titanium alloy material with a crystalline titanium oxide film formed on the surface thereof, the method comprising:

(1) performing roughening treatment on the surface of a metal titanium material or titanium alloy material to form a roughened material,

(2) forming a titanium compound on the surface of the roughened material obtained in step (1),

(3) performing anodizing treatment on the material with the titanium compound formed on the surface thereof obtained in step (2) in an electrolyte solution having no etching properties for titanium to form an amorphous titanium oxide film, and

(4) performing heat treatment on the material with the amorphous titanium oxide film formed on the surface thereof obtained in step (3) in at least one atmosphere selected from the group consisting of an air atmosphere, a mixed atmosphere of oxygen gas and nitrogen gas, and an oxygen gas atmosphere at a temperature of 300° C. or more to form a crystalline titanium oxide film.

Item 2. The production method according to Item 1, wherein the roughening treatment of step (1) is blast treatment.

Item 3. The production method according to Item 1 or 2, wherein chemical etching treatment is further performed after the roughening treatment of step (1).

Item 4. The production method according to any one of Items 1 to 3, wherein the titanium compound formed in step (2) is at least one compound selected from the group consisting of titanium nitride, titanium carbide, titanium carbonitride, and titanium boronitride.

Item 5. The production method according to any one of Items 1 to 4, wherein step (2) is a step of forming titanium nitride on the surface of the roughened material by performing heat treatment under a nitrogen gas atmosphere using an oxygen-trapping agent.

Item 6. The production method according to any one of Items 1 to 4, wherein step (2) is a step of forming at least one compound selected from the group consisting of titanium carbide, titanium carbonitride, and titanium boronitride on the surface of the roughened material by performing at least one treatment selected from the group consisting of CVD, thermal CVD, RF plasma CVD, PVD, thermal spraying treatment, ion plating, and sputtering.

Item 7. The production method according to any one of Items 1 to 6, wherein the electrolyte solution having no etching properties for titanium used in the anodizing treatment of step (3) is an electrolyte solution comprising at least one compound selected from the group consisting of inorganic acids, organic acids, and salts thereof.

Item 8. The production method according to any one of Items 1 to 7, wherein the temperature of the heat treatment of step (4) is 300 to 700° C.

Item 9. The production method according to any one of Items 1 to 8, wherein the crystalline titanium oxide film is a film of anatase-type titanium oxide.

Item 10. The production method according to any one of Items 1 to 9, wherein the metal titanium material or titanium alloy material with a crystalline titanium oxide film formed on the surface thereof is used for at least one application selected from the group consisting of photocatalyst materials, photoelectric conversion element materials, wear-resistant members, and edible oil deterioration-preventing members.

Item 11. A metal titanium material or titanium alloy material with a crystalline titanium oxide film formed on the surface thereof, produced by the production method according to any one of Items 1 to 10.

Item 12. A metal titanium material or titanium alloy material with a crystalline titanium oxide film formed on the surface thereof, the material having an average surface roughness (Ra) of 0.1 to 100 μm.

### Advantageous Effects of Invention

The present invention can produce a metal titanium material or titanium alloy material with a crystalline titanium oxide film formed on the surface thereof.

The metal titanium material or titanium alloy material with a crystalline titanium oxide film formed on the surface thereof is useful as a photocatalyst material, a photoelectric conversion element material, a wear-resistant member, an edible oil deterioration-preventing member, and the like that have high functionality.

### BRIEF DESCRIPTION OF DRAWINGS

FIG. 1 is a diagram showing the amount of crystalline titanium oxide formed on the titanium material of the present invention.

FIG. 2 is a diagram showing the photocatalytic activity of the titanium material of the present invention.

### DESCRIPTION OF EMBODIMENTS

The present invention is described in detail below.

In the present specification, metal titanium materials and titanium alloy materials are also simply referred to as “titanium materials.”

The present invention relates to a method for producing a metal titanium material or titanium alloy material with a crystalline titanium oxide film formed on the surface thereof, the method comprising:

(1) performing roughening treatment on the surface of a metal titanium material or titanium alloy material to form a roughened material,

(2) forming a titanium compound on the surface of the roughened material obtained in step (1),

(3) performing anodizing treatment on the material with the titanium compound formed on the surface thereof obtained in step (2) in an electrolyte solution having no etching properties for titanium to form an amorphous titanium oxide film, and

(4) performing heat treatment on the material with the amorphous titanium oxide film formed on the surface thereof obtained in step (3) in at least one atmosphere selected from the group consisting of an air atmosphere, a mixed atmosphere of oxygen gas and nitrogen gas, and an oxygen gas atmosphere at a temperature of 300° C. or more to form a crystalline titanium oxide film.

1. Method for Producing Titanium Material with Crystalline Titanium Oxide Film Formed on Surface Thereof

### (1) Step of Performing Roughening Treatment

The method for producing a titanium material with a crystalline titanium oxide film formed on the surface thereof according to the present invention comprises (1) performing roughening treatment on the surface of a metal titanium material or titanium alloy material (titanium material) to form a roughened material (roughening step).

Since the photocatalytic reaction and the edible oil deterioration-preventing reaction are surface reactions, the efficiency of the photocatalytic reaction and the edible oil deterioration-preventing effect is more improved as there are more contact opportunities between the photocatalyst material and components to be subjected to the photocatalytic reaction, and between the edible oil deterioration-preventing member and edible oil, that is, as the surface area is larger.

Therefore, it is preferable to perform mechanical roughening treatment, such as blast treatment, before forming a titanium compound on the surface of the titanium material. Further, it is preferable to perform chemical etching after the blast treatment.

The surface-treated titanium material obtained in this manner has a larger amount of anatase-type titanium oxide film formed on the surface thereof, and thus can be preferably used as a photoelectric conversion element material, such as a photoelectrode substrate for dye-sensitized solar cells, which have attracted attention as next-generation solar cells.

The metal titanium material is metal titanium itself. When a titanium alloy material is used, the type thereof is not particularly limited. As the titanium alloy, it is preferable to use Ti-6Al-4V, Ti-4.5Al-3V-2Fe-2Mo, Ti-0.5Pd, or the like.

As the method for roughening the titanium material, it is preferable to perform at least one treatment selected from the group of electrolytic treatment, electric discharge machining, blast treatment, plasma etching, and the like.

In the method for producing a titanium material with a crystalline titanium oxide film formed on the surface thereof according to the present invention, the roughening treatment of step (1) is preferably blast treatment. The blast treatment is mechanical roughening treatment, and is preferable because the equipment and process can be simplified.

As the blast treatment, it is preferable to select at least one method selected from the group consisting of sand blast, shot blast, grit blast, and bead blast. As the blast treatment, there are a direct-pressure type and a suction type.

As the abrasive material (blast particles) used in the blast treatment, alumina (aluminum oxide), glass beads, silicon carbide (SiC), steel grid, steel shot, and the like can be preferably used. For the blast treatment, it is preferable to use at least one abrasive material selected from the group consisting of the above-mentioned abrasive materials. The above abrasive materials may be used in combination.

The particle diameter of the abrasive material (blast particles) used in the blast treatment is preferably 5 μm to 3,000 μm. The particle diameter of the abrasive material (blast particles) is preferably 20 μm to 2,000 μm, more preferably 30 μm to 500 μm, and even more preferably 50 μm to 100 μm.

As the abrasive material (blast particles), for example, #12 (particle diameter: 1,410 μm to 1,680 μm), #24 (particle diameter: 590 μm to 710 μm), #150 (particle diameter: 63 μm to 74 μm), and the like can be preferably used. In the blast treatment, for example, Alumina Particles #150 (alumina particle diameter: 63 μm to 74 μm), Alumina Particles #12 (alumina particle diameter: 1,410 μm to 1680 μm), and Alumina Particles #24 (alumina particle diameter: 590 μm to 710 μm), all of which are produced by Japan Carlit Co., Ltd., can be preferably used.

When shot blast treatment is performed, the surface of the metal titanium plate (titanium material) may be roughened using a blast treatment device (BA-1, direct-pressure type, produced by Atsuchi Tekko Co., Ltd.).

First, the metal titanium plate (titanium material) and an abrasive material (grinding material) are placed in the device. Next, air is taken in by a compressor, and the pressure is adjusted to about 0.5 MPa. Then, the abrasive material (grinding material) is discharged toward the metal titanium plate (titanium material) in direct-pressure mode to perform shot blast treatment.

In the method for producing a titanium material with a crystalline titanium oxide film formed on the surface thereof according to the present invention, it is preferable to further perform chemical etching treatment after the roughening treatment (preferably blast treatment) in step (1). Performing chemical etching treatment on the surface of the titanium material after blast treatment is preferable because the abrasive material and blast debris of the titanium material can be removed from the surface of the blasted titanium material.

By performing chemical etching treatment, irregular edges formed by shot blast treatment can be melted, and sharp irregularities can be changed to a surface with smooth undulations. By this chemical etching treatment, the subsequent anodizing treatment can be uniformly performed on the material surface.

In the chemical etching treatment, it is preferable to use an aqueous solution of an acid as an etching agent. As the aqueous acid solution, it is more preferable to use an aqueous solution of at least one acid selected from the group consisting of hydrofluoric acid, nitric-hydrofluoric acid (mixed acid of hydrofluoric acid and nitric acid), ammonium hydrogen fluoride, sulfuric acid, hydrochloric acid, and oxalic acid. As the aqueous acid solution, it is even more preferable to use hydrofluoric acid for the titanium material.

The treatment conditions of chemical etching can be adjusted by the type and concentration of the aqueous acid solution etc. For example, when a hydrofluoric acid aqueous solution is used as the chemical etching treatment, the concentration of hydrofluoric acid is generally 0.5 wt. % or more, and more preferably about 1 wt. % to 5 wt. %.

The etching temperature of the chemical etching treatment can be adjusted by the type of acid, the concentration of the aqueous solution thereof, and the like. For example, when hydrofluoric acid is used as the chemical etching treatment, the temperature is generally about 10° C. to 40° C., and preferably about 20° C. to 30° C.

Further, the chemical etching treatment is not limited to etching using a chemical. As the chemical etching treatment, a method of electrolytic reduction under cathode polarization may be used.

### Average Surface Roughness (Ra) of Roughened Material

The average surface roughness (Ra) of the roughened material formed by performing roughening treatment on the surface of the titanium material can be adjusted by using the above-mentioned abrasive materials (blast particles) or by performing chemical etching treatment.

The average surface roughness (Ra) of the roughened material formed by performing roughening treatment on the surface of the titanium material is preferably about 0.1 μm to 100 μm, for example. The average surface roughness (Ra) of the roughened material formed by performing roughening treatment on the surface of the titanium material is more preferably about 1 μm or more, even more preferably about 1.5 μm or more, and particularly preferably about 2 μm or more.

The average surface roughness (Ra) of the roughened material formed by performing roughening treatment on the surface of the titanium material is, for example, preferably in the range of about 1 μm to 100 μm, more preferably in the range of about 1.5 μm to 50 μm, and particularly preferably in the range of about 2 μm to 20 μm.

The average surface roughness (Ra) of the material can be measured, for example, by a method according to ISO 4287. The average surface roughness (Ra) can be measured, for example, using a surface roughness meter such as Talysurf S4C/H503 (produced by Taylor Hobson).

### (2) Step of Forming Titanium Compound

The method for producing a titanium material with a crystalline titanium oxide film formed on the surface thereof according to the present invention comprises (2) forming a titanium compound on the surface of the roughened material obtained in step (1).

The titanium compound formed in step (2) is preferably at least one compound selected from the group consisting of titanium nitride, titanium carbide, titanium carbonitride, and titanium boronitride. The titanium compound formed in step (2) is more preferably at least one compound selected from the group consisting of titanium nitride (TiN), titanium carbide (TiC), titanium carbonitride (TiCN), and titanium boronitride (TiBN).

When titanium nitride is formed in step (2), it is preferable to form titanium nitride on the surface of the roughened material by performing heat treatment under a nitrogen gas atmosphere using an oxygen-trapping agent.

Step (2) is preferably a step of forming at least one compound selected from the group consisting of titanium carbide, titanium carbonitride, and titanium boronitride on the surface of the roughened material by performing at least one treatment selected from the group consisting of CVD, thermal CVD, RF plasma CVD, PVD, thermal spraying treatment, ion plating, and sputtering.

In the present invention, it is preferable to form at least one compound selected from the group consisting of titanium nitride, titanium carbide, titanium carbonitride, and titanium boronitride on the roughened titanium material.

Case in which Titanium Nitride is Formed on Titanium Material

The method for forming titanium nitride on the surface of the titanium material is preferably PVD treatment, CVD treatment, thermal spraying treatment, heat treatment under an ammonia gas atmosphere, heat treatment under a nitrogen gas atmosphere, or the like. It is preferable to perform heat treatment under a nitrogen gas atmosphere, in terms of convenience, safety, and profitability.

The heat treatment under a nitrogen gas atmosphere is preferably performed using an oxygen-trapping agent (in the presence of an oxygen-trapping agent). The oxygen-trapping agent used in the heat treatment of the titanium material is preferably a substance or gas having a higher oxygen affinity than that of the titanium material.

As the oxygen-trapping agent, for example, a carbon material, metal powder, hydrogen gas, etc., can be preferably used. These oxygen-trapping agents may be used singly or in a combination of two or more. It is preferable to use a carbon material, in terms of convenience, profitability, and safety.

Carbon materials are not particularly limited. Examples of carbon materials include graphite carbon, amorphous carbon, carbon having an intermediate crystal structure between graphite carbon and amorphous carbon, and the like. The carbon material may have any shape, such as plate, foil, or powder. It is preferable to use a plate carbon material, in terms of good handling properties, and because the thermal strain of the titanium material during heat treatment can be prevented.

The reaction pressure of the heat treatment under a nitrogen gas atmosphere is preferably about 0.01 MPa to 1 MPa, and more preferably about 0.05 MPa to 0.5 MPa. The reaction pressure of the heat treatment under a nitrogen gas atmosphere is more preferably 0.1 MPa, in terms of profitability, safety, convenience, etc.

The heat treatment time under a nitrogen gas atmosphere is preferably about 1 minute to 12 hours, more preferably 10 minutes to 8 hours, and even more preferably 1 hour to 6 hours.

As the method for performing heat treatment on the titanium material under a nitrogen gas atmosphere, in order to efficiently form titanium nitride on the surface of the titanium material, it is preferable to reduce the pressure in the furnace using a rotary vacuum pump and optionally a mechanical booster pump or an oil diffusion pump, and to reduce the concentration of oxygen remaining in the furnace for heat treatment. The rotary vacuum pump, mechanical booster pump, and oil diffusion pump used to reduce the pressure in the furnace may be used singly or in a combination of two or more.

As the degree of vacuum in the furnace before heat treatment, the pressure is preferably reduced to about 10 Pa or less, more preferably about 1 Pa or less, and even more preferably about 0.1 Pa or less. By this decompression treatment, titanium nitride can be efficiently formed on the surface of the titanium material.

Further, it is preferable to alternately repeat the decompression treatment that reduces the remaining oxygen concentration in the furnace for heat treatment, and the pressure-returning treatment that supplies nitrogen gas into the furnace. The oxygen concentration in the furnace can be further reduced (in a state in which almost no oxygen is present) by alternately repeating the decompression treatment and the pressure-returning treatment. As a result of this treatment, the titanium material cannot react with oxygen but reacts with nitrogen, whereby titanium nitride can be more efficiently formed on the surface of the titanium material.

Case in which Titanium Carbide, Titanium Carbonitride, or Titanium Boronitride is Formed on Titanium Material

A known film formation method can be applied as the method for forming at least one compound selected from the group consisting of titanium carbide, titanium carbonitride, and titanium boronitride on the surface of the roughened material (titanium material) (film formation method). Specifically, it is preferable to perform at least one treatment selected from the group consisting of CVD, thermal CVD, RF plasma CVD, PVD, thermal spraying treatment, ion plating, and sputtering.

### (3) Step of Performing Anodizing Treatment

The method for producing a titanium material with a crystalline titanium oxide film formed on the surface thereof according to the present invention comprises (3) performing anodizing treatment on the material with a titanium compound formed on the surface thereof obtained in step (2) in an electrolyte solution having no etching properties for titanium to form an amorphous titanium oxide film. An amorphous titanium oxide film can be formed by performing the anodizing treatment.

Since the step of performing anodization is performed under conditions that do not generate spark discharge, a film of crystalline titanium oxide, such as anatase-type titanium oxide, is generally not formed. By performing heat treatment in the next step, a crystalline titanium oxide film can be formed from amorphous titanium oxide.

The film of crystalline titanium oxide (preferably anatase-type titanium oxide) is a useful material as a photocatalyst material, a photoelectric conversion element material, a wear-resistant member, an edible oil deterioration-preventing member, and the like.

The anodizing treatment of the present invention is not associated with the spark discharge phenomenon and thus does not require a high current. Further, in the anodizing treatment of the present invention, the electrolyte solution does not generate much heat; thus, neither an expensive power supply device for applying a high current nor a high power is required. Moreover, since the calorific value of the electrolyte solution is not so high, an expensive cooling device is not required, and the profitability is thus high.

The electrolyte solution having no etching properties for titanium used in the anodizing treatment of step (3) is preferably an electrolyte solution containing at least one compound selected from the group consisting of inorganic acids, organic acids, and salts thereof.

Phosphoric acid, carbonic acid, or the like is preferably used as the inorganic acid having no etching properties for titanium. Acetic acid, lactic acid, or the like is preferably used as the organic acid having no etching properties for titanium. Further, as salt compounds of these acids, it is preferable to use sodium hydrogen phosphate, sodium dihydrogen phosphate, sodium hydrogen carbonate, sodium acetate, sodium lactate, and the like. In addition, it is preferable to use an electrolyte solution containing sodium sulfate, potassium sulfate, sodium nitrate, potassium nitrate, or the like.

Phosphoric acid and/or phosphate is most preferable as the inorganic acid. For example, in an electrolyte solution containing phosphoric acid and/or phosphate, the concentration is preferably about 0.01 wt. % to 10 wt. %. The concentration thereof in the electrolyte solution is more preferably about 0.1 wt. % to 10 wt. %, and more preferably about 1 wt. % to 3 wt. %.

These acids and salt compounds may be used singly or in a combination of two or more. The total concentration of the acid(s) and/or salt compound(s) in the electrolyte solution is preferably about 0.01 wt. % to 10 wt. %, more preferably about 0.1 wt. % to 10 wt. %, and even more preferably about 1 wt. % to 3 wt. %.

Compared with anodization associated with the spark discharge phenomenon, the anodizing treatment of the present invention does not require a higher current, and the electrolyte solution does not generate much heat. Accordingly, the anodizing treatment of the present invention is preferable because it requires nether an expensive power supply device for applying a high current, nor a high power. The anodizing treatment of the present invention is also capable of treating large-area materials because the calorific value of the electrolyte solution is not so high, and an expensive cooling device is not required; thus, it is advantageous in terms of profitability, safety, mass productivity, etc.

It is preferable to perform anodizing treatment by immersing the titanium material with a titanium compound formed thereon in an electrolyte solution having no etching effect on titanium.

The temperature of the anodizing treatment is preferably about 10° C. to 50° C., and more preferably about 20° C. to 30° C. The time of the anodizing treatment is preferably about 1 minute to 30 minutes, and more preferably about 5 minutes to 20 minutes.

### (4) Step of Performing Heat Treatment

The method for producing a titanium material with a crystalline titanium oxide film formed on the surface thereof according to the present invention comprises (4) performing heat treatment on the material with an amorphous titanium oxide film formed on the surface thereof obtained in step (3) in at least one atmosphere selected from the group consisting of an air atmosphere, a mixed atmosphere of oxygen gas and nitrogen gas, and an oxygen gas atmosphere at a temperature of 300° C. or more to form a crystalline titanium oxide film.

The present invention comprises performing anodizing treatment on the titanium material with a titanium compound formed thereon. An amorphous titanium oxide film can be formed on the surface of the titanium material by performing anodizing treatment on the titanium material with a titanium compound formed thereon. Next, the titanium material with an amorphous titanium oxide film formed on the surface thereof can be heated in an oxidizing atmosphere, thereby forming crystalline titanium oxide on the surface of the titanium material.

When the titanium material is only heated in an oxidizing atmosphere, rutile-type titanium dioxide is formed, but anatase-type titanium oxide is not formed.

The heat treatment is performed in an oxidizing atmosphere. The atmosphere of the heat treatment may be selected from an air oxidizing atmosphere, any oxygen-containing mixed gas atmosphere in which oxygen gas and nitrogen gas are mixed, an oxygen gas atmosphere, and the like. The heat treatment is preferably performed in at least one atmosphere selected from the group consisting of these atmospheres. As the oxidizing atmosphere of the heat treatment, the heat treatment is preferably performed in an air oxidizing atmosphere, in terms of convenience, profitability, safety, etc.

The heat treatment in an oxidizing atmosphere is performed at a temperature of 300° C. or more. A crystalline titanium oxide film can be formed from the amorphous titanium oxide film by this heat treatment. The heat treatment temperature in an oxidizing atmosphere is preferably about 300° C. to 800° C., and more preferably about 400° C. to 700° C., in terms of further preventing the formation of rutile-type titanium dioxide.

The reaction pressure of the heat treatment is preferably about 0.01 MPa to 10 MPa, and more preferably about 0.1 MPa to 1 MPa. In terms of convenience, profitability, safety, etc., the reaction pressure of the heat treatment is more preferably about 0.1 MPa. The time of the heat treatment is preferably about 10 minutes to 8 hours, and more preferably about 30 minutes to 6 hours. In terms of convenience, profitability, safety, etc., the time of the heat treatment is more preferably about 1 hour.

The crystalline titanium oxide film is preferably a film of anatase-type titanium oxide.

According to the production method of the present invention, a titanium material with a crystalline titanium oxide film formed on the surface thereof can be produced.

Average Surface Roughness (Ra) of Titanium Material with Crystalline Titanium Oxide Film Formed on Surface Thereof

The average surface roughness (Ra) of the titanium material with a crystalline titanium oxide film formed on the surface thereof can be adjusted by using the above-mentioned abrasive materials (blast particles) or by performing chemical etching treatment.

The average surface roughness (Ra) of the titanium material with a crystalline titanium oxide film formed on the surface thereof is preferably 0.1 to 100 μm, for example. The average surface roughness (Ra) of the titanium material with a crystalline titanium oxide film formed on the surface thereof is preferably about 1 μm or more, more preferably about 1.5 μm or more, and particularly preferably about 2 μm or more.

The average surface roughness (Ra) of the titanium material with a crystalline titanium oxide film formed on the surface thereof is, for example, preferably in the range of about 1 μm to 100 μm, more preferably in the range of about 1.5 μm to 50 μm, and particularly preferably in the range of about 2 μm to 20 μm.

The average surface roughness (Ra) of the material can be measured, for example, by a method according to ISO 4287. The average surface roughness (Ra) can be measured, for example, using a surface roughness meter such as Talysurf S4C/H503 (produced by Taylor Hobson).

2. Titanium Material with Crystalline Titanium Oxide Film Formed on Surface Thereof

According to the production method of the present invention, a titanium material with a crystalline titanium oxide film formed on the surface thereof can be produced.

The present invention relates to a metal titanium material or titanium alloy material with a crystalline titanium oxide film formed on the surface thereof, the material having an average surface roughness (Ra) of 0.1 to 100 μm.

The titanium material with a crystalline titanium oxide film formed on the surface thereof is preferably a material used for at least one application selected from the group consisting of photocatalyst materials, photoelectric conversion element materials, wear-resistant members, and edible oil deterioration-preventing members.

The crystalline titanium oxide film is preferably a film of anatase-type titanium oxide.

(1) Average Surface Roughness (Ra) of Titanium Material with Crystalline Titanium Oxide Film Formed on Surface Thereof

The average surface roughness (Ra) of the titanium material with a crystalline titanium oxide film formed on the surface thereof can be adjusted by using the above-mentioned abrasive materials (blast particles) or by performing chemical etching treatment.

The average surface roughness (Ra) of the titanium material with a crystalline titanium oxide film formed on the surface thereof is preferably 0.1 to 100 μm, for example. The average surface roughness (Ra) of the roughened material formed by performing roughening treatment on the surface of the titanium material is preferably about 1 μm or more, more preferably about 1.5 μm or more, and particularly preferably about 2 μm or more.

The average surface roughness (Ra) of the roughened material formed by performing roughening treatment on the surface of the titanium material is, for example, more preferably in the range of about 1 μm to 100 μm, even more preferably in the range of about 1.5 μm to 50 μm, and particularly preferably in the range of about 2 μm to 20 μm.

The average surface roughness (Ra) of the material can be measured, for example, by a method according to ISO 4287. The average surface roughness (Ra) can be measured, for example, using a surface roughness meter such as Talysurf S4C/H503 (produced by Taylor Hobson).

The average surface roughness (Ra) of the titanium material with a crystalline titanium oxide film formed on the surface thereof can be measured by a method according to ISO 4287. The average surface roughness (Ra) can be measured, for example, using a surface roughness meter such as Talysurf S4C/H503 (produced by Taylor Hobson).

### (2) Photocatalyst Material and Photoelectric Conversion Element Material

The titanium material with a crystalline titanium oxide film formed on the surface thereof according to the present invention is preferably used for applications, such as photocatalyst materials and photoelectric conversion element materials. The titanium material can be applied to photocatalyst materials having high functionality.

The titanium material with a crystalline titanium oxide film formed on the surface thereof according to the present invention has high photocatalytic activity and thus has a bactericidal effect. The titanium material with a crystalline titanium oxide film formed on the surface thereof according to the present invention can be used as a material for decomposing hazardous substances in the gas phase or the liquid phase. The titanium material with a crystalline titanium oxide film formed on the surface thereof according to the present invention can also impart hydrophilicity.

The titanium material with a crystalline titanium oxide film formed on the surface thereof according to the present invention can be used as a photocatalyst material.

Since the photocatalyst material of the present invention has a crystalline titanium oxide film formed on the surface thereof and thus has an excellent sterilizing effect, it can be applied not only to water purification in hot springs and sterilization of microorganisms in ballast tanks, but also to the medical field.

In methods for water purification in pools, baths, hot springs, etc., hypochlorous acid, sodium hypochlorite, and the like are used. When sodium hypochlorite is used, sufficient effects may not be expected in some cases, and chlorine odor is a problem.

Since the photocatalyst material of the present invention has a crystalline titanium oxide film formed on the surface thereof and thus has an excellent bactericidal effect, it is possible to purify water in pools, baths, hot springs, etc., by removing microorganisms, bacteria, and the like present therein. Further, the use of the photocatalyst material of the present invention does not result in the generation of chlorine odor.

Ships, particularly cargo ships, are designed in consideration of the weight of cargo to be loaded etc.; thus, in the case of an empty load, there are various obstacles, such as an increase in the center of gravity of the ship, a decrease in stability, and a high probability to overturn. Therefore, countermeasures have been taken to stabilize the hull by loading seawater etc., which are used as weight, in ballast tanks provided in the ship.

In this case, since the loading port and the discharging port are different, aquatic organisms contained in the ballast water come and go between countries, causing problems such as disturbance of the ecosystem on a global scale. Accordingly, sodium hypochlorite is used for killing and sterilizing microorganisms contained in the ship ballast water etc. The use of sodium hypochlorite causes a problem of corrosion of materials constituting the ballast tanks.

Since the photocatalyst material of the present invention has a crystalline titanium oxide film formed on the surface thereof and thus has an excellent sterilizing effect, it is possible to kill and sterilize microorganisms contained in ship ballast water and the like. In addition, since the photocatalyst material of the present invention uses a titanium material, which has complete corrosion resistance to seawater, it can be used semi-permanently and does not corrode ballast tanks.

Organic compounds, such as formaldehyde generated from structural materials, including plywood, decorative boards, adhesives, and paints, in houses and offices, and acetaldehyde, which is a tobacco odor substance, may cause health hazards.

Since the photocatalyst material of the present invention has a crystalline titanium oxide film formed on the surface thereof, it can decompose and remove these volatile organic compounds (VOCs) and the like.

Regarding hazardous substances in the gas phase, there is a problem that a large amount of sulfur oxide (SOx) etc., which cause acid rain, is generated in the process of burning fossil fuels in coal-fired power plants etc., and in the process of burning sulfur contained in heavy oil, which is used as fuel for ships (e.g., in a boiler).

Since the photocatalyst material of the present invention has a crystalline titanium oxide film formed on the surface thereof, it can be used in a device for decomposing hazardous substances, such as sulfur oxide (SOx).

Volatile organic compounds (VOCs), such as trichloroethylene, used in industrial cleaning and harmful metals in factory effluent have recently entered soil, causing serious soil pollution.

The photocatalyst material of the present invention can be used in a device for decomposing hazardous substances, such as volatile organic compounds (VOCs) that cause soil contamination.

Further, the photocatalyst material of the present invention can be used not only for decomposing hazardous substances adhering to PM2.5, but also applied to building structures, such as indoor wall materials, building outer walls, and roof materials.

There are known methods of anodizing metal titanium or a titanium alloy in a dilute solution of an acid having no etching effect. However, only amorphous titanium oxide, which does not has a crystal structure, is formed by these methods, and the amorphous titanium oxide does not exhibit photocatalytic characteristics or photoelectric conversion characteristics for dye-sensitized solar cells.

The crystalline titanium oxide film is preferably an anatase-type titanium oxide film. The energy level of the conduction band of anatase-type titanium oxide is nobler than that of rutile-type titanium dioxide. Therefore, electrons excited in the conduction band of anatase-type titanium oxide efficiently contribute to the reaction, and the photocatalytic activity is higher than that of rutile-type titanium dioxide. In addition, anatase-type titanium oxide has higher photoelectric conversion characteristics because the open-circuit voltage value is improved over when rutile-type titanium dioxide is used for the photoelectrode of a dye-sensitized solar cell.

The titanium material with a crystalline titanium oxide film formed on the surface thereof according to the present invention has a film with a large amount of anatase-type titanium oxide, which has high photocatalytic activity and dye-sensitized solar cell characteristics. When the titanium material with a crystalline titanium oxide film formed on the surface thereof according to the present invention is used as a photocatalyst material, it is possible to exhibit an extremely high-performance photocatalytic function, as compared with conventional photocatalyst materials whose substrates are coated with titanium oxide fine particles.

Anatase-type titanium oxide is a photocatalyst that causes an oxidation reaction in such a manner that upon irradiation with near-ultraviolet light corresponding to the band gap, holes are generated in the valence band and electrons are generated in the conduction band. Active oxygen, such as OH radical, is generated by this oxidation reaction, and the active oxygen oxidizes and decomposes hazardous substances in the gas phase or the liquid phase.

Since the photocatalytic reaction is a surface reaction, the efficiency of the photocatalytic reaction is more improved as there are more contact opportunities between the photocatalyst material and components to be subjected to the photocatalytic reaction. It is thus desirable to perform mechanical roughening treatment, such as blast treatment, before forming a titanium compound. It is also desirable to perform chemical etching after performing blast treatment.

Since an anatase-type titanium oxide film is formed on the surface of the titanium material with a crystalline titanium oxide film formed on the surface thereof according to the present invention, it can also be used as a photoelectric conversion element material, such as a photoelectrode substrate for dye-sensitized solar cells, which have attracted attention as next-generation solar cells.

### (3) Edible Oil Deterioration-Preventing Member

The titanium material with a crystalline titanium oxide film formed on the surface thereof according to the present invention is preferably used for edible oil deterioration-preventing members.

The titanium material with a crystalline titanium oxide film formed on the surface thereof according to the present invention can be applied to edible oil deterioration-preventing members. Specifically, the deterioration of edible oil can be suppressed by bringing the edible oil deterioration-preventing member of the present invention into contact with the edible oil during cooking, regardless of the type, shape, and size of cooking container and the type of edible oil. It is also possible to suppress the decrease in flavor and nutritional value caused by the deterioration of edible oil. Further, the life of edible oil can be improved.

Furthermore, since the increase in the viscosity of edible oil is prevented and oil drainage is improved, it is possible to cook fried food with a crispy texture. Thus, the texture of the cooked product is also improved.

Edible oil is deteriorated by a reaction with oxygen molecules in the air during cooking, an oxidation reaction accompanied by heat, or a reaction with water molecules in food. The acid value (AV) for determining the deterioration of edible oil increases through the following steps. The heated edible oil combines with oxygen to increase the peroxide value (POV). Then, the carbonyl value (CV) increases. Aldehydes, which are carbonyl compounds, are extremely chemically unstable and affect the taste and physical condition. Subsequently, water molecules and the edible oil undergo a chemical reaction, turning them into carboxylic acids. These acids appear as AV.

General titanium oxide has one titanium atom and two oxygen atoms that are chemically bonded to each other.

In contrast, anatase-type titanium oxide has areas called lattice defects where oxygen does not partially exist. Oxygen molecules are easily taken into the lattice defect sites where oxygen does not exist. Oxygen molecules in the air during cooking are chemically adsorbed to the lattice defect sites of anatase-type titanium oxide on the surface of the edible oil deterioration-preventing member. Due to this action, the edible oil has fewer opportunities to come into contact with oxygen molecules, and the formation of peroxides, which is the initial reaction of the edible oil deterioration reaction, can be effectively suppressed.

Water molecules are also chemically adsorbed to the lattice defect sites of anatase-type titanium oxide on the surface of the edible oil deterioration-preventing member. Due to this action, the edible oil has fewer opportunities to come into contact with water molecules, and the hydrolysis reaction, which is an edible oil deterioration reaction, can be effectively prevented, thereby suppressing the increase in the acid value (AV).

In the present invention, the oxygen lattice defect sites of anatase-type titanium oxide can be increased by performing a series of surface treatment techniques, i.e., (1) performing roughening treatment on the surface of a titanium material, and optionally performing chemical etching treatment, then (2) forming a titanium compound, then (3) performing anodization in an electrolyte solution having no etching properties for titanium to form an amorphous titanium oxide film, and then (4) performing heat treatment in an oxidizing atmosphere.

When the titanium material with a crystalline titanium oxide film formed on the surface thereof according to the present invention is used as an edible oil deterioration-preventing member, the deterioration of edible oil can be efficiently suppressed. The edible oil deterioration-preventing reaction is a surface reaction. It is possible to more efficiently suppress the deterioration of edible oil as there are more contact opportunities between the edible oil deterioration-preventing member of the present invention and the edible oil. It is thus desirable to perform mechanical roughening treatment, such as blast treatment, before forming a titanium compound.

The edible oils targeted by the present invention are not particularly limited. Examples include soybean oil, rapeseed oil, palm oil, olive oil, salad oil, cottonseed oil, cacao oil, sunflower oil, corn oil, rice oil, lard, sardine oil, whale oil, and the like.

### (4) Wear-Resistant Member

The titanium material with a crystalline titanium oxide film formed on the surface thereof according to the present invention is preferably used for wear-resistant members.

The titanium material with a crystalline titanium oxide film formed on the surface thereof according to the present invention has extremely high Vickers hardness and excellent abrasion resistance, and thus can be used for wear-resistant members. Specifically, the Vickers hardness of metal titanium is about 170. When the surface treatment of the present invention is performed, the Vickers hardness is as extremely high as about 1,000 to 4,000, although it varies depending on the type of titanium compound.

Wear-resistant members are applied to dies, roll members, tools, etc. It is possible to extend the life of dies, roll members, and tools by improving wear resistance. In addition, it is possible to produce a photocatalyst material, a photoelectric conversion element material, and an edible oil deterioration-preventing member, all of which have good wear resistance.

The titanium material with a crystalline titanium oxide film formed on the surface thereof according to the present invention exhibits good wear resistance when used, for example, as a photocatalyst material, a photoelectric conversion element material, or an edible oil deterioration-preventing member. The titanium material with a crystalline titanium oxide film formed on the surface thereof according to the present invention can be used stably for a long period of time even in a severe environment.

According to the production method of the present invention, it is possible to produce materials having excellent high corrosion resistance inherent in titanium materials, while maintaining the good wear resistance of photocatalyst materials, photoelectric conversion element materials, and edible oil deterioration-preventing members.

### EXAMPLES

An embodiment of the present invention is a metal titanium material with a crystalline titanium oxide film formed on the surface thereof, obtained by (1) performing roughening treatment on a metal titanium material, then (2) forming a titanium compound, then (3) performing anodizing treatment in an electrolyte solution having no etching properties for metal titanium, and finally (4) performing heat treatment.

In an embodiment of the prior art, a material was produced by (1) performing roughening treatment on a metal titanium material, then (3) performing anodizing treatment in an electrolyte solution having no etching properties for metal titanium, and finally (4) performing heat treatment. In another embodiment of the prior art, a metal titanium material with a crystalline titanium oxide film formed on the surface thereof was produced by (2) forming a titanium compound on a metal titanium material, then (3) performing anodizing treatment in an electrolyte solution having no etching properties for metal titanium, and finally (4) performing heat treatment. Unlike the material of the present invention, the materials of the prior art are produced without performing “roughening treatment” in step (1) or produced without “forming a titanium compound” in step (2).

### Example 1

Average Surface Roughness (Ra) of Titanium Material with Crystalline Titanium Oxide Film Formed on Surface Thereof

### (1-1) Step 1: Production of Roughened Titanium Material

In order to compare the amount of anatase-type titanium oxide formed, materials were produced under two conditions; i.e., with and without shot blast treatment.

In the case of a material subjected to shot blast treatment, the surface of a metal titanium plate (titanium material, photoelectrode substrate) was roughened using a blast treatment device (BA-1, direct-pressure type, produced by Atsuchi Tekko Co., Ltd.).

First, the metal titanium plate and a grinding material (Alumina #150, produced by Japan Carlit Co., Ltd., alumina particle diameter: 63 μm to 74 μm) were placed in the device. Next, air was taken in by a compressor, and the pressure was adjusted to 0.5 MPa.

Similarly, blast treatment was performed using Alumina Particles #12 (alumina particle diameter: 1,410 μm to 1,680 μm) and Aluminum Particles #24 (alumina particle diameter: 590 μm to 710 μm), both of which are produced by Japan Carlit Co., Ltd.

The grinding material was discharged toward the substrate in direct-pressure mode, and shot blast treatment was performed for 30 seconds per side. The shot blast treatment was performed on both sides of the substrate.

The average surface roughness Ra of the blasted materials (samples) was measured. The average surface roughness (Ra) was measured by a method according to ISO 4287. The average surface roughness (Ra) was measured using, for example, Talysurf S4C/H503 (produced by Taylor Hobson).

Table 1 shows the average surface roughness (Ra) after roughening treatment.

### Average Surface Roughness (Ra) of Roughened Material

TABLE 1
Table 1

| Blast treatment | Blast particles | Ra (μm) |
|---|---|---|
| Direct-pressure mode | #12 | 9.88 |
| | (Particle diameter: 1,410 μm-1,680 μm) | |
| | #24 | 6.29 |
| | (Particle diameter: 590 μm-710 μm) | |
| | #150 | 2.14 |
| | (Particle diameter: 63 μm-74 μm) | |

In the embodiment of the present invention, the titanium material was subjected to roughening treatment. On the other hand, in the embodiment of the prior art, the titanium material was not subjected to roughening treatment.

### (1-2) Production of Anodized Titanium Material

### Step 2: Formation of Titanium Compound on Surface of Roughened Material

After the metal titanium plate and the shot-blasted metal titanium plate were degreased with trichloroethylene, titanium nitride was formed on the surface of the degreased metal titanium plates using a nitriding furnace (NVF-600-PC, produced by Nakanihon-Ro Kogyo Co., Ltd.).

Specifically, first, each metal titanium plate was held by a plate carbon material placed in the nitriding furnace. Subsequently, in order to remove oxygen, the pressure in the nitriding furnace was reduced to 1 Pa or less, and then high-purity (99.99% or more) nitrogen gas was introduced into the nitriding furnace to return the pressure to 0.1 MPa.

Then, the temperature of the nitriding furnace was raised to 950° C. over 2 hours. Thereafter, heat treatment was performed in the nitriding furnace at 950° C. for 1 hour, thereby forming titanium nitride on the surface of each metal titanium plate.

In the embodiment of the present invention, a titanium compound was formed on the material after roughening treatment. On the other hand, in the embodiment of the prior art, no titanium compound was formed on the material after roughening treatment.

### Step 3: Anodizing Treatment

The metal titanium plate with titanium nitride formed on the surface thereof (the present invention) was anodized using a DC stabilized power supply PU300-5 (produced by TEXIO) in a 1 wt. % phosphoric acid aqueous solution (produced by Wako Pure Chemical Industries, Ltd.) at a current density of 0.5 A/dm² for 10 minutes. By this anodizing treatment, an amorphous titanium oxide film was formed on the surface of the titanium material.

In the embodiments of the prior art, anodizing treatment was also performed on the titanium material that was not subjected to roughening treatment or on the titanium material that was not subjected to formation of a titanium compound.

### Step 4: Heat Treatment

The metal titanium plate with a titanium oxide film formed on the surface thereof (the present invention) was heated under an air atmosphere using an electric furnace (MB-242020, produced by Koyo Thermo Systems Co., Ltd.).

First, the metal titanium plate with a titanium oxide film formed thereon was placed in the electric furnace, and the door of the electric furnace was closed and sealed. Then, the temperature was raised to 670° C. over 1 hour. Next, the temperature was raised to 700° C. over 30 minutes, and after reaching 700° C., the temperature was continuously maintained for 1 hour, thereby forming an anatase-type titanium oxide film (crystalline titanium oxide film) on the surface of the titanium material.

In the embodiments of the prior art, heat treatment was also performed on the titanium material that was not subjected to roughening treatment or on the titanium material that was not subjected to formation of a titanium compound.

The average surface roughness (Ra) of the materials (samples) was measured. The average surface roughness (Ra) was measured by a method according to ISO 4287. The average surface roughness (Ra) was measured using Talysurf S4C/H503 (produced by Taylor Hobson).

Table 2 shows the average surface roughness (Ra) after heat treatment of the present invention and the prior art. Unlike the material of the present invention, the material of the prior art is produced without forming a titanium compound in step (2).

By performing blast treatment before forming a titanium compound on the surface of the titanium material, the surface roughness of the titanium material could be increased, and the surface area of the titanium material could be increased.

Average Surface Roughness (Ra) of Titanium Material with Crystalline Titanium Oxide Film Formed on Surface Thereof

TABLE 2
Table 2

| Blast treatment | Blast particles | Ra (μm) |
|---|---|---|
| Direct-pressure mode | #12 | 9.64 |
| | (Particle diameter: 1,410 μm-1,680 μm) | |
| | #24 | 6.02 |
| | (Particle diameter: 590 μm-710 μm) | |
| | #150 | 2.21 |
| | (Particle diameter: 63 μm-74 μm) | |
| Prior art | #150 | 2.04 |
| without nitriding treatment | (Particle diameter: 63 μm-74 μm) | |

For the sample of blast particles #150, the amount of XRD anatase formed was measured in Example 2, and the photocatalytic activity was measured in Example 3.

### Example 2

### Amount of Crystalline Titanium Oxide Film Formed on Surface of Titanium Material

### (2-1) Production of Anodized Titanium Material

In order to compare the amount of anatase-type titanium oxide (crystalline titanium oxide film) formed, materials were prepared under two conditions; i.e., with and without shot blast treatment.

In the case of a material subjected to shot blast treatment, the surface of a metal titanium plate (titanium material, photoelectrode substrate) was roughened using a blast treatment device (BA-1, direct-pressure type, produced by Atsuchi Tekko Co., Ltd.).

First, the metal titanium plate and a grinding material (Alumina #150, produced by Japan Carlit Co., Ltd., alumina particle diameter: 63 μm to 74 μm) were placed in the device. Next, air was taken in by a compressor, and the pressure was adjusted to 0.5 MPa.

The grinding material was discharged toward the substrate in direct-pressure mode, and shot blast treatment was performed for 30 seconds per side. The shot blast treatment was performed on both sides of the substrate.

After the metal titanium plate and the shot-blasted metal titanium plate were degreased with trichloroethylene, titanium nitride was formed on the surface of the degreased metal titanium plates using a nitriding furnace (NVF-600-PC, produced by Nakanihon-Ro Kogyo Co., Ltd.).

Specifically, first, each metal titanium plate was held by a plate carbon material placed in the nitriding furnace. Subsequently, in order to remove oxygen, the pressure in the nitriding furnace was reduced to 1 Pa or less, and then high-purity (99.99% or more) nitrogen gas was introduced into the nitriding furnace to return the pressure to 0.1 MPa.

Then, the temperature of the nitriding furnace was raised to 950° C. over 2 hours. Thereafter, heat treatment was performed in the nitriding furnace at 950° C. for 1 hour, thereby forming titanium nitride on the surface of each metal titanium plate.

The metal titanium plate with titanium nitride formed on the surface thereof was anodized using a DC stabilized power supply PU300-5 (produced by TEXIO) in a 1 wt. % phosphoric acid aqueous solution (produced by Wako Pure Chemical Industries, Ltd.) at a current density of 0.5 A/dm² for 10 minutes to form an amorphous titanium oxide film.

The metal titanium plate with a titanium oxide film formed on the surface thereof was heated under an air atmosphere using an electric furnace (MB-242020, produced by Koyo Thermo Systems Co., Ltd.).

First, the metal titanium plate with a titanium oxide film formed thereon was placed in the electric furnace, and the door of the electric furnace was closed and sealed. Then, the temperature was raised to 670° C. over 1 hour. Next, the temperature was raised to 700° C. over 30 minutes, and after reaching 700° C., the temperature was maintained for 1 hour, thereby forming an anatase-type titanium oxide film on the surface of the titanium material.

### (2-2) Results of X-Ray Diffraction

The amount of anatase-type titanium oxide (crystalline titanium oxide film) formed on the anodized metal titanium plate on the shot-blasted substrate was XRD-measured at an accelerating voltage of 30 kV using an X-ray diffractometer (MiniFlex II, produced by Rigaku Corporation).

The material of the present invention was compared with the metal titanium plate that was anodized without performing shot blast treatment (the prior art). Further, the material of the present invention was compared with the metal titanium plate that was anodized without forming a titanium compound (the prior art). Unlike the material of the present invention, the materials of the prior art are produced without performing roughening treatment in step (1) or produced without forming a titanium compound in step (2).

Table 3 shows the amounts of anatase-type titanium oxide formed in the present invention and the prior art. In the shot-blasted material of the present invention, the amount of anatase-type titanium oxide (crystalline titanium oxide film) was increased about twice as much as that in the material that was not subjected to blast treatment.

In the material with a titanium compound formed thereon according to the present invention, the amount of anatase-type titanium oxide formed was about three times as much as that in the material that was not subjected to nitriding treatment.

### Amount of Anatase-Type Titanium Oxide (Crystalline Titanium Oxide Film) Formed

TABLE 3
Table 3

| | XRD integral intensity |
|---|---|
| Type of material | anatase 101 plane |
| Present invention | 411.41 |
| with blast treatment | |
| with nitriding treatment | |
| Prior art | 237.59 |
| without blast treatment | |
| Prior art | 136.96 |
| without nitriding treatment | |

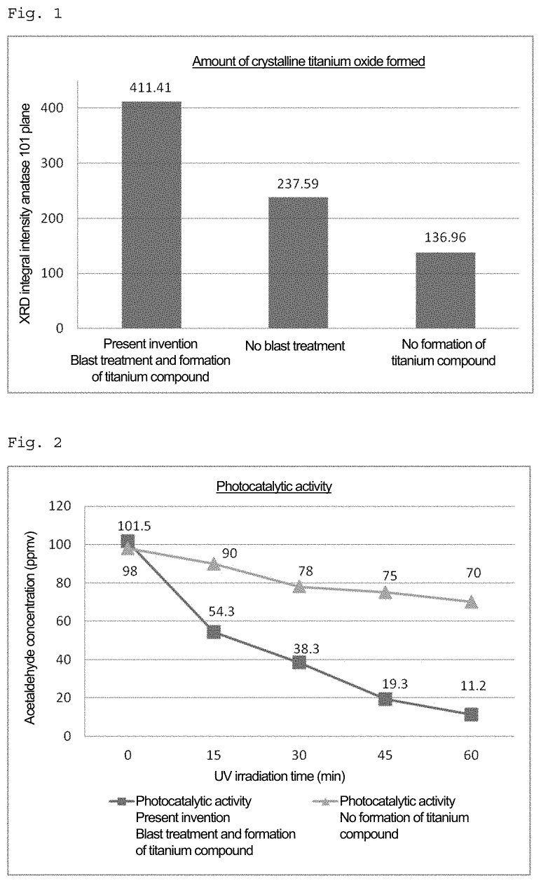

### FIG. 1: Graph of Amount of Crystalline Titanium Oxide Formed

In the metal titanium material with a crystalline titanium oxide film formed on the surface thereof produced by the method for producing a titanium material according to the present invention, a larger amount of crystalline titanium oxide film was formed on the surface thereof, as compared with the prior art.

### Example 3

Photocatalytic Activity of Titanium Material with Crystalline Titanium Oxide Film Formed on Surface Thereof

### (3-1) Production of Anodized Titanium Material

The surface of a metal titanium plate (titanium material, photoelectrode substrate) was roughened using a blast treatment device (BA-1, direct-pressure type, produced by Atsuchi Tekko Co., Ltd.).

First, the metal titanium plate and a grinding material (Alumina #150, produced by Japan Carlit Co., Ltd., alumina particle diameter: 63 μm to 74 μm) were placed in the device. Next, air was taken in by a compressor, and the pressure was adjusted to 0.5 MPa.

The grinding material was discharged toward the substrate in direct-pressure mode, and shot blast treatment was performed for 30 seconds per side. The shot blast treatment was performed on both sides of the substrate.

Next, after the shot-blasted titanium metal plate was degreased with trichloroethylene, titanium nitride was formed on the surface of the degreased metal titanium plate using a nitriding furnace (NVF-600-PC, produced by Nakanihon-Ro Kogyo Co., Ltd.).

Specifically, first, the metal titanium plate was held by a plate carbon material placed in the nitriding furnace. Subsequently, in order to remove oxygen, the pressure in the nitriding furnace was reduced to 1 Pa or less, and then high-purity (99.99% or more) nitrogen gas was introduced into the nitriding furnace to return the pressure to 0.1 MPa.

Then, the temperature of the nitriding furnace was raised to 950° C. over 2 hours. Thereafter, heat treatment was performed in the nitriding furnace at 950° C. for 1 hour, thereby forming titanium nitride on the surface of the metal titanium plate.

The metal titanium plate with titanium nitride formed on the surface thereof was anodized using a DC stabilized power supply PU300-5 (produced by TEXIO) in a 1 wt. % phosphoric acid aqueous solution (produced by Wako Pure Chemical Industries, Ltd.) at a current density of 0.5 A/dm² for 10 minutes to form an amorphous titanium oxide film.

The metal titanium plate with a titanium oxide film formed on the surface thereof was heated under an air atmosphere using an electric furnace (MB-242020, produced by Koyo Thermo Systems Co., Ltd.).

First, the metal titanium plate with a titanium oxide film formed thereon was placed in the electric furnace, and the door of the electric furnace was closed and sealed. Then, the temperature was raised to 670° C. over 1 hour. Next, the temperature was raised to 700° C. over 30 minutes, and after reaching 700° C., the temperature was maintained for 1 hour, thereby forming an anatase-type titanium oxide film (crystalline titanium oxide film) on the surface of the titanium material.

### (3-2) Evaluation Results of Photocatalytic Activity

The photocatalytic activity of the surface-treated metal titanium plate was evaluated by photolysis of acetaldehyde.

First, the photocatalytic substrate was adjusted to a size of 100 mm×100 mm×1 mm in thickness. Next, the metal titanium plate and acetaldehyde gas (100 ppmv, 3 L) were placed in a Tedlar bag (produced by Aswan).

Using a black light emitting near-ultraviolet light that allows photoexcitation of anatase-type titanium oxide (produced by Toshiba Lighting & Technology Corporation), near-ultraviolet light with a light intensity adjusted to 2.2 mW/cm² was irradiated from above.

The acetaldehyde concentration was measured every 15 minutes (Table 4).

The photocatalytic activities of the material of the present invention and the materials of the prior art were evaluated by photolysis of acetaldehyde and compared. The material of the present invention was compared with the metal titanium plate that was anodized without forming a titanium compound (the prior art). Unlike the material of the present invention, this material of the prior art is produced without forming a titanium compound in step (2).

As shown in Table 4, the material of the present invention had an acetaldehyde concentration sufficiently reduced after UV irradiation, and showed higher photocatalytic activity than that of the material of the prior art, which was produced without forming a titanium compound.

### Photocatalytic Activity

TABLE 4
Table 4

Photocatalytic activity
Acetaldehyde concentration

| UV | Present invention | Prior art |
|---|---|---|
| irradiation | with blast treatment | without nitriding |
| time | with nitriding treatment | treatment |
| 0 min | 101.5 ppmv | 98 ppmv |
| 15 min | 54.3 ppmv | 90 ppmv |
| 30 min | 38.3 ppmv | 78 ppmv |
| 45 min | 19.3 ppmv | 75 ppmv |
| 60 min | 11.2 ppmv | 70 ppmv |

### FIG. 2: Graph of Photocatalytic Activity

In the metal titanium material with a crystalline titanium oxide film formed on the surface thereof produced by the method for producing a titanium material according to the present invention, a crystalline titanium oxide film was well formed on the surface thereof; thus, compared with the prior art, a larger amount of crystalline titanium oxide film was formed on the surface thereof, and higher photocatalytic activity was exhibited.

### Comparison Between the Present Invention and the Prior Art

Present invention: (1) roughening treatment→4 (2) nitriding treatment, which is titanium compound treatment→4 (3) anodizing treatment→4 (4) heat treatment

Prior art 1: (2) nitriding treatment, which is titanium compound treatment→4 (3) anodizing treatment→4 (4) heat treatment

Prior art 2: (1) roughening treatment→4 (3) anodizing treatment→4 (4) heat treatment

TABLE 5
Table 5

| Features of the present invention | Prior art 1 | Prior art 2 |
|---|---|---|
| Method for producing titanium | | |
| material | | |
| (1) Roughening treatment of | Not performed | Performed |
| titanium material | | |
| (Step of forming roughened | | |
| material) | | |
| (2) Step of forming titanium | Performed | Not performed |
| compound | | |
| (3) Anodizing treatment | Performed | Performed |
| (formation of amorphous titanium | | |
| oxide film) | | |
| (4) Heat treatment in oxidizing | Performed | Performed |
| atmosphere | | |
| (formation of crystalline titanium | | |
| oxide film) | | |
| Effects of the present invention | | |
| A larger amount of crystalline | Without roughening | Without formation of a titanium |
| titanium oxide film formed | treatment, a smaller amount | compound, a smaller amount of |
| Good photocatalytic activity etc. | of crystalline titanium oxide | crystalline titanium oxide film formed |
| Useful material | film formed | Poor photocatalytic activity etc. |
| | | Not a useful material. |

In the method for producing a titanium material of the present invention, a metal titanium material with a crystalline titanium oxide film formed on the surface thereof can be produced through the entire series of steps (1) to (4). The present invention exhibits the following advantageous effects due to its technical features.

Since the photocatalytic reaction and the edible oil deterioration-preventing reaction are surface reactions, the efficiency of the photocatalytic reaction and the edible oil deterioration-preventing effect is more improved as there are more contact opportunities between the photocatalyst material and components to be subjected to the photocatalytic reaction, and between the edible oil deterioration-preventing member and edible oil, that is, as the surface area is larger. Further, dye-sensitized solar cells having a larger surface area have higher photoelectric conversion efficiency.

In the method for producing a titanium material with a crystalline titanium oxide film formed on the surface thereof according to the present invention, roughening treatment (blast treatment) is performed (step (1)) before a titanium compound is formed on the surface of the titanium material, whereby the surface roughness of the titanium material can be increased, and the surface area of the titanium material can be increased.

The present invention comprises step (3) of performing anodizing treatment on the material with a titanium compound formed on the surface thereof obtained in step (2) in an electrolyte solution having no etching properties for titanium to form an amorphous titanium oxide film. An amorphous titanium oxide film can be formed by performing this anodizing treatment.

In the present invention, the heat treatment of step (4) is performed subsequent to the step of performing anodization, whereby a crystalline titanium oxide film can be preferably formed from amorphous titanium oxide.

The crystalline titanium oxide film is a useful material as a photocatalyst material, a photoelectric conversion element material, a wear-resistant member, an edible oil deterioration-preventing member, and the like.

1. A method for producing a metal titanium material or titanium alloy material with a crystalline titanium oxide film formed on the surface thereof, the method comprising:
(1) performing roughening treatment on the surface of a metal titanium material or titanium alloy material to form a roughened material,
(2) forming a titanium compound on the surface of the roughened material obtained in step (1),
(3) performing anodizing treatment on the material with the titanium compound formed on the surface thereof obtained in step (2) in an electrolyte solution having no etching properties for titanium to form an amorphous titanium oxide film, and
(4) performing heat treatment on the material with the amorphous titanium oxide film formed on the surface thereof obtained in step (3) in at least one atmosphere selected from the group consisting of an air atmosphere, a mixed atmosphere of oxygen gas and nitrogen gas, and an oxygen gas atmosphere at a temperature of 300° C. or more to form a crystalline titanium oxide film.

2. The production method according to claim 1, wherein the roughening treatment of step (1) is blast treatment.

3. The production method according to claim 1, wherein chemical etching treatment is further performed after the roughening treatment of step (1).

4. The production method according to claim 1, wherein the titanium compound formed in step (2) is at least one compound selected from the group consisting of titanium nitride, titanium carbide, titanium carbonitride, and titanium boronitride.

5. The production method according to claim 1, wherein step (2) is a step of forming titanium nitride on the surface of the roughened material by performing heat treatment under a nitrogen gas atmosphere using an oxygen-trapping agent.

6. The production method according to claim 1, wherein step (2) is a step of forming at least one compound selected from the group consisting of titanium carbide, titanium carbonitride, and titanium boronitride on the surface of the roughened material by performing at least one treatment selected from the group consisting of CVD, thermal CVD, RF plasma CVD, PVD, thermal spraying treatment, ion plating, and sputtering.

7. The production method according to claim 1, wherein the electrolyte solution having no etching properties for titanium used in the anodizing treatment of step (3) is an electrolyte solution comprising at least one compound selected from the group consisting of inorganic acids, organic acids, and salts thereof.

8. The production method according to claim 1, wherein the temperature of the heat treatment of step (4) is 300 to 700° C.

9. The production method according to claim 1, wherein the crystalline titanium oxide film is a film of anatase-type titanium oxide.

10. The production method according to claim 1, wherein the metal titanium material or titanium alloy material with a crystalline titanium oxide film formed on the surface thereof is used for at least one application selected from the group consisting of photocatalyst materials, photoelectric conversion element materials, wear-resistant members, and edible oil deterioration-preventing members.
